(19) United States
(12) Patent Application Publication
(10) Pub. No.: US 2013/0070853 A1
(43) Pub. Date: Mar. 21, 2013

(54) Image Searching Module and Searching Method Thereof

(71) Applicant: Wei-Yu Wu, Taoyuan City (TW)

(72) Inventor: Wei-Yu Wu, Taoyuan City (TW)

(73) Assignee: HANNSTAR DISPLAY CORP., New Taipei City (TW)

(21) Appl. No.: 13/369,019

(22) Filed: Feb. 8, 2012

(30) Foreign Application Priority Data
Sep. 20, 2011 (TW) 100133874

(51) Int. Cl. H04N 7/32; H04N 7/26

(52) U.S. Cl. 375/240.16; 375/E07.125; 375/E07.243

(57) ABSTRACT

An image searching module and a searching method thereof are applicable to motion estimation of a dynamic image-processing system. The image searching module comprises a storage module, a setting module, and a processing module. The storage module stores a first frame, and the first frame has a first block and a first pixel. The setting module sets a plurality of first estimation blocks with a first estimation pixel and a first interval as a side length in a second frame. The setting module sets an initiation point on the position corresponding to the first pixel in the second frame, and arranges these first estimation blocks in order along a predetermined direction. The processing module matches each first estimation block and the first block to work out respectively a first predicted strength value of each first estimation block corresponding to the first block.

### CROSS-REFERENCE TO RELATED APPLICATION

This application claims the benefit of priority to Taiwan Patent Application No. 100133874, filed on Sep. 20, 2011, in the Taiwan Intellectual Property Office the disclosure of which is incorporated herein by reference.

### BACKGROUND OF THE INVENTION

1. Field of the Invention

The present invention relates to a motion compensation technique, and more particularly to an image searching module and a searching method thereof, which is capable of improving motion estimation mechanism.

2. Description of the Related Art

Motion estimation system is widely used in a video processing system, and may be applied to applications of visual compressing, sample rate conversion and image filtering. Currently, the motion estimation mechanism in video compression standards, such as MPEG-1/2/4 or ITU-T H.261/262/263/264, is that after dividing frames into a plurality of blocks, the dynamic program is performed, and block content data of two images are compared. The motion vector obtained by the computation then renders a virtual middle image by interpolation to complete dynamic compensation, thereby reducing temporal redundancy between dynamic frames.

For example, in the current search mechanism of motion estimation, a 6×6 block is taken as a basic unit, and it is assumed that a pixel at an upper left corner is taken as an initial pixel which is a first estimation pixel. Taking the initial pixel as a central point, its up and down and left right each is extended with three-pixel in length to be a search scope, so that the first estimation pixel must perform the search and comparison for forty-nine times to compute and obtain vector predicted strength of the first estimation pixel. Further, each 6×6 block respectively has thirty-six pixels. Therefore, each 6×6 block respectively has thirty-six vector predicted strength. Each vector predicted strength is obtained by computing the search comparison for forty-nine times. Taking blocks as basic units for motion estimation to search full-field frames, image data of each pixel is sequentially compared to consume longer search time for motion estimation operation, and consequentially it will generate enormous amount of computation data.

### SUMMARY OF THE INVENTION

In view of the shortcomings of the prior art, the inventor(s) of the present invention based on years of experience in the related industry to conduct extensive researches and experiments, and finally developed an image searching module and a searching method thereof as a principle objective to achieve reducing the search frequency and search time and decreasing the amount of computation data and computation time under a premise that images are distortionless.

To achieve the foregoing objective of the invention, an image searching module is provided and includes a storage module, a setting module and a processing module. The storage module stores a first frame having a first block and a first pixel. The setting module sets a plurality of first estimation blocks in a second frame, and each first estimation block has a first estimation pixel. Further, a first interval is taken as a side length, and the setting module takes the same position corresponding to the first pixel in the second frame as an initiation point, and the first estimation blocks are sequentially arranged along a predetermined direction. The processing module is connected to the setting module to capture and compare image data in each first estimation block of the second frame with image data in the first block of the first frame so as to sequentially compute a first predicted strength of each first estimation block relative to the first block.

Wherein, the setting module further includes a plurality of second estimation blocks. Each second estimation block has a second estimation pixel, and a second interval as a side length. The second estimation blocks take the first estimation pixel having the minimum first predicted strength as an initiation point and are sequentially arranged along the predetermined direction. The processing module respectively captures and compares image data in each second estimation block with image data in the first block so as to sequentially compute a second predicted strength of each second estimation block relative to the first block.

The setting module further includes a plurality of third estimation blocks, and the third estimation block has a third estimation pixel. A third interval is taken as a side length. The third estimation blocks take the second estimation pixel having the minimum second predicted strength as an initiation point and are sequentially arranged along the predetermined direction. The processing module respectively captures and compares image data in the third estimation blocks with image data in the first block to sequentially compute a third predicted strength of each third estimation block relative to the first block.

Wherein, the second interval is smaller than the first interval, and the third interval is smaller than the second interval.

The processing module respectively compares the first block with each first estimation block, each second estimation block or each third estimation block and sequentially computes them to obtain a plurality of sums of absolute differences.

Wherein, each sum of absolute difference is respectively the first predicted strength, the second predicted strength or the third predicted strength.

In addition, the invention further provides an image searching method, which is applicable to a motion estimation in a dynamic image processing system and that uses an image searching module to perform the search operation of motion vector. The image searching module includes a storage module, a setting module and a processing module. The image searching method includes the following steps: store a first frame through the processing module to set a first block in the first frame; take a first interval as a side length to form a plurality of first estimation blocks; dispose the first estimation blocks in a second frame through the setting module; take the same position of corresponding to the first pixel in the first block as an initiation point, and sequentially arrange each first estimation block along a predetermined direction; capture and compare image data in each first estimation block with image data in the first block through the processing module; and sequentially compute a first predicted strength of each first estimation block relative to the first block.

Wherein, the image searching method of the invention further includes: take a second interval as a side length to form a plurality of second estimation blocks; dispose the second estimation blocks in the second frame through the setting module; take the first pixel having the minimum first predicted strength as an initiation point, and sequentially arrange each second estimation block along the predetermined direction; capture and compare image data in each second estimation block with image data in the first block through the processing module; and sequentially compute a second predicted strength of the second estimation block relative to the first block.

The image searching method of the invention further includes: take a third interval as a side length to form a plurality of third estimation blocks; dispose the third estimation blocks in the second frame through the setting module; take the second estimation pixel having the smallest second predicted strength, and sequentially arrange each third estimation block; capture and compare image data in each third estimation block with image data in the first block through the processing module; and sequentially compute a third predicted strength of each third estimation block relative to the first block.

Wherein, the processing module respectively compares the first block with each first estimation block, each second estimation block or each third estimation block and sequentially computes them to obtain a plurality of sums of absolute differences.

Wherein, each sum of absolute differences is respectively the first predicted strength, the second predicted strength or the third predicted strength.

An image searching module and the method thereof according to the invention have one or more advantages as the following:
(1) The image searching module and the searching method thereof can reduce computation and search times by disposing different sizes of estimation blocks under a premise that images are distortionless.
(2) The image searching module and the searching method thereof can achieve the efficacy of reducing computed data amount by gradually converging on estimation block scopes.

### BRIEF DESCRIPTION OF THE DRAWINGS

FIG. 1 is a block diagram of an image searching module according to a first embodiment of the invention;

FIG. 2 is a schematic diagram of an image searching method according to the invention;

FIG. 3A is a schematic diagram of a first frame of an image searching method according to a first embodiment of the invention;

FIG. 3B is a schematic diagram of a second frame of an image searching method according to a first embodiment of the invention;

FIG. 4 is a flowchart of an image searching method according to a first embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

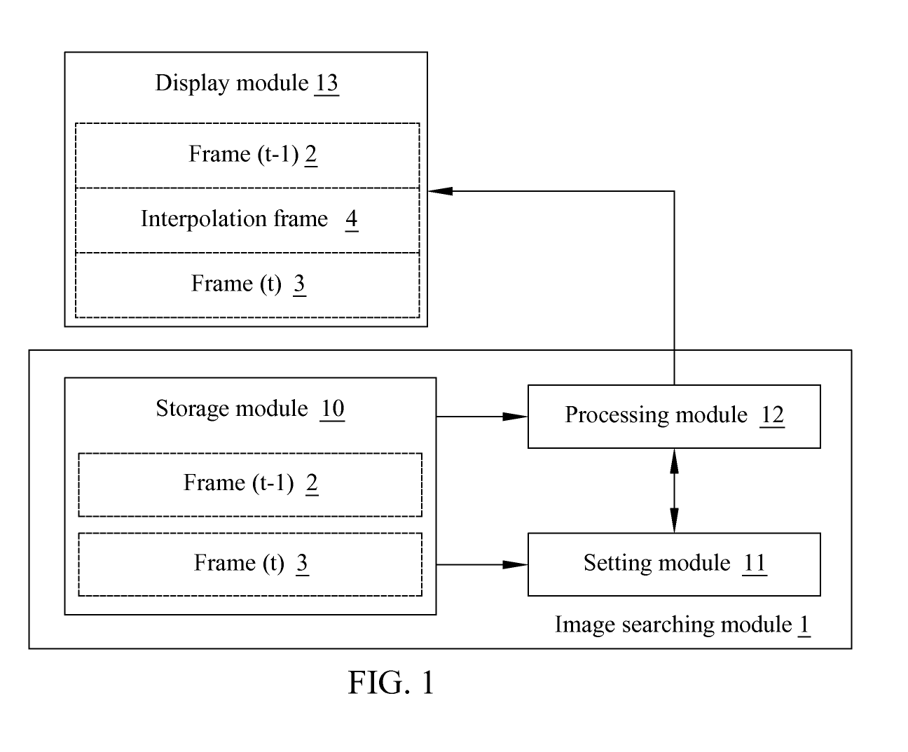

With reference to FIG. 1 for a block diagram of an image searching module according to a first embodiment of the invention is depicted. As shown in the figure, the image searching module 1 is applicable to motion estimation of a dynamic image processing system and includes a storage module 10, a setting module 11 and a processing module 12, The storage module 10 can be an embedded memory, an external memory card or combination thereof capable of storing frame (t-1) 2 and frame (t) 3 captured or received by the dynamic image processing system. The setting module 11 is connected to the storage module 10 and the processing module 12, and the setting module 11 can divide frame (t-1) 2 into a plurality of blocks to obtain image data in the image block to be searched. Further, the setting module 11 disposes a plurality of estimation blocks in frame (t) 3 so that image data can be obtained in the block scope through the estimation blocks. Next, the processing module 12 mutually compares with image data obtained by the estimation blocks based upon block image data in frame (t) 3 so as to compute and obtain the motion vector of frame (t-1) 2 and frame (t) 3. Accordingly, the moving relatedness between two frames can be estimated to generate a virtual interpolation frame 4. Next, the processing module 12 can sequentially output frame (t-1) 2, the interpolation frame 4 and frame (t) 3 to a display module 13 to continue the dynamic motion of images.

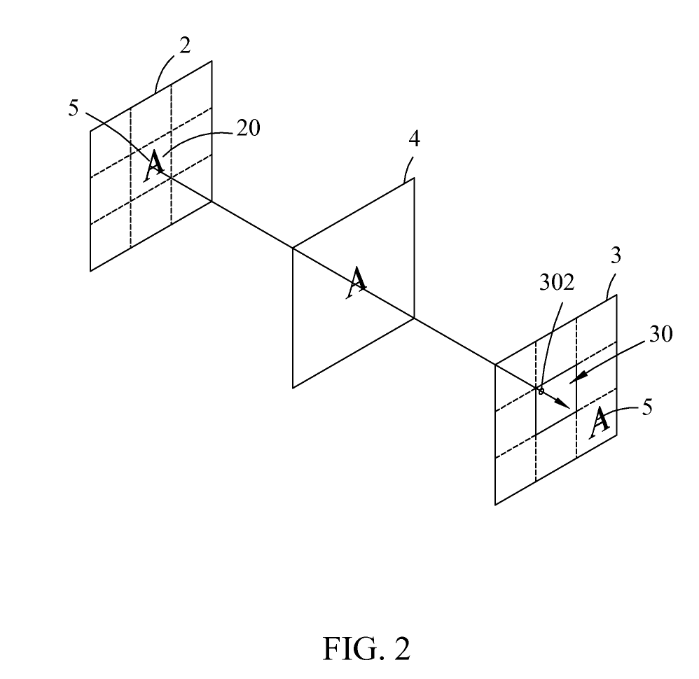

With reference to FIG. 2 for a schematic diagram of an image searching method according to the invention is depicted. As shown in the figure, frame (t-1) 2 and frame (t) 3 captured or received by the dynamic image processing system are taken as two compared image frames having time sequence. Each image frame has a plurality of pixels, and each image frame is divided by taking blocks as a fundamental unit. Frame (t-1) 2 has an A-shaped pattern 5. Image data within the A-shaped pattern 5 can be divided into a first block 20. Further, a plurality of first estimation blocks 30 is disposed in frame (t) 3. Each first estimation block 30 can be a quadrate block in which the side length is eight-pixel length. Suppose the position of left upper corner of each first estimation block 30 is the first estimation pixel 302.

Next, in frame (t) 3, the same position of the A-shaped pattern 5 in frame (t-1) 2 is taken as an initiation point. Therefore, the first estimation pixel 302 is placed on the initiation point, and each first estimation block 30 is sequentially arranged in outward spirality along a predetermined direction such as a clockwise direction or a counterclockwise direction. Image data in the block scope is obtained through the first estimation blocks 30. The moving relationship between frame (t-1) 2 and the A-shaped pattern in frame (t) 3 is estimated through comparison and computation so as to generate a virtual interpolation frame 4. The interpolation frame 4 is placed between frame (t-1) 2 and frame (t) 3 to continue the dynamic behavior of images.

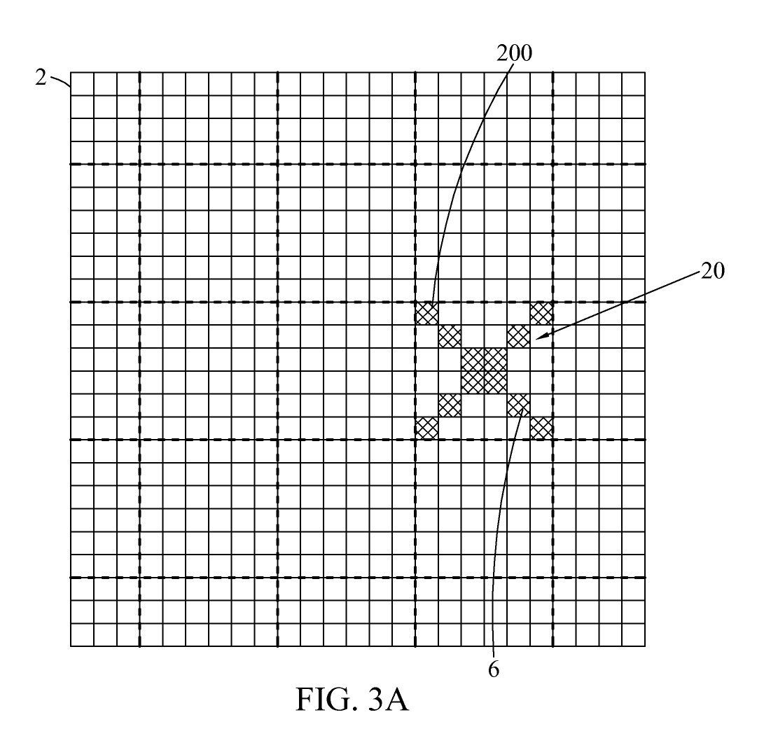

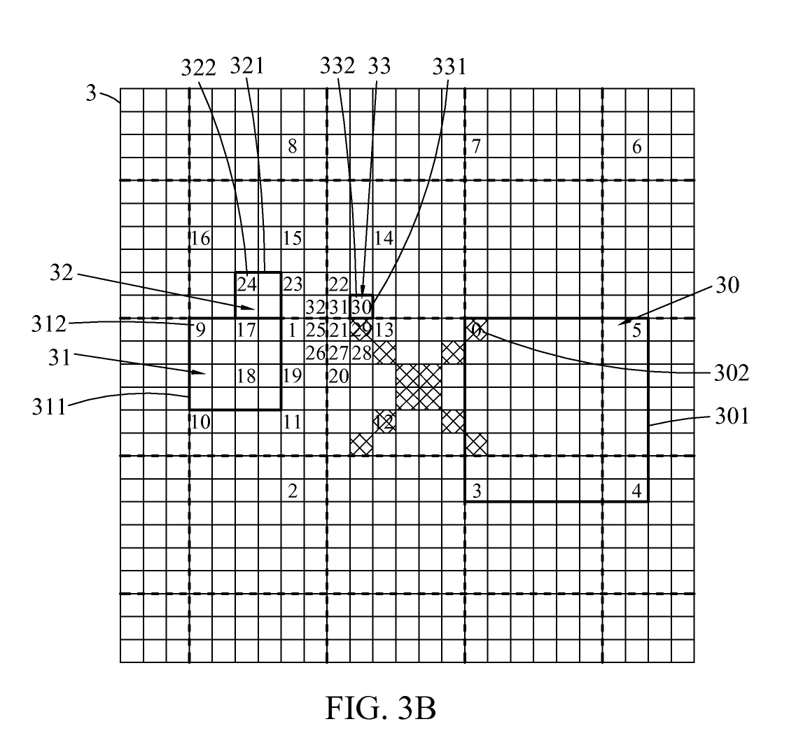

With reference to FIG. 3A and FIG. 3B, FIG. 3A is a schematic diagram of a first frame of an image searching method according to a first embodiment of the invention. FIG. 3B is a schematic diagram of a second frame of an image searching method according to a first embodiment of the invention. As shown in the figures, the first frame and the second frame, e.g. frame (t-1) 2 and frame (t) 3, captured or received by the dynamic image processing system are taken as comparison image frames around time sequence. Each image frame has a plurality of pixels, and each image frame is divided by taking blocks as a fundamental unit. Frame (t-1) 2 has an X-shaped pattern 6, and image data in the X-shaped pattern 6 can be divided into a first block 20. The pixel at the left upper corner of the first block 20 is set as a first pixel 200. The first pixel 200 is taken as an initial pixel for motion estimation.

In frame (t) 3, a plurality of first estimation blocks 30 is disposed. Each first estimation block 30 can take a first interval 301 as a side length to form a rectangle block having 8×8 pixel lengths. Suppose the left upper corner of each first estimation block 30 is a first estimation pixel 302. In frame (t) 3, the same position of corresponding to the X-shaped pattern 6 in frame (t-1) 2 is taken as an initiation point. The first estimation pixel 302 is placed to the position of the starting point, and each first estimation block 30 is sequentially arranged in outward spirality along a predetermined direction such as a clockwise direction or a counterclockwise direction.

In the embodiment, the initiation point of disposing the first estimation blocks 30 can be at a 0 position, and the first estimation pixel 302 is sequentially placed at positions of 1, 2, 3, 4, 5, 6, 7 and 8 in a counterclockwise direction so that each first estimation block 30 is sequentially and outwardly expanded at the positions of 1, 2, 3, 4, 5, 6, 7 and 8. Further, the first estimation blocks are compared with image data corresponding to frame (t-1) 2 for computation to obtain a sum of absolute difference (SAD) of corresponding positions between the first estimation blocks 30 and frame (t-1) 2. In another word, after image data of each pixel of the first estimation blocks 30 is respectively and sequentially subtracted from image data of corresponding position in frame (t-1) 2, the absolute value of difference is obtained, and all values are added together to obtain the sum. Moreover, the sum of absolute difference is a first predicted strength of the first estimation pixel 302. Similarly, image data in corresponding position according to time t-1 frame 2 is sequentially compared with the first estimation blocks 30 at positions of 1, 2, 3, 4, 5, 6, 7 and 8 to obtain a plurality of sums of absolute differences. The first estimation pixel 302 of the first estimation blocks 30 having the sum of the minimum absolute difference will have the greatest first estimation strength that is a motion vector of the first pixel 200 in the X-shaped pattern 6.

The first estimation pixel 302 in the first estimation blocks 30 having the sum of the minimum absolute difference are taken as the initiation point, a plurality of second estimation blocks 31 is sequentially disposed in a counterclockwise direction. In the embodiment, each second estimation block 31 can be a quadrate block formed by the second interval 311 in which the side length is four pixel lengths. Suppose a left upper corner of each second estimation block 31 is a second estimation pixel 312. The second estimation pixel 312 is used for comparing with and computing the initial pixel.

In the embodiment, the first estimation blocks 30 of a position 1 have a sum of the smallest absolute difference. Therefore, taking the position 1 as an initiation point, and each second estimation pixel 312 is sequentially and arranged at positions of 9, 10, 11, 12, 13, 14, 15 and 16 so that each second estimation block 31 is sequentially and outwardly expanded to respectively obtain image data. According to image data in the first block 20, image data in the second estimation blocks 31 at positions of 9, 10, 11, 12, 13, 14, 15 and 16 are respectively compared. The sum of absolute difference between the second estimation blocks 31 and the first estimation blocks 20 is obtained to find out the second predicted strength of each second estimation pixel 312. The second estimation pixel 312 having the greatest second predicted strength is a motion vector of the first pixel 200.

The searching scope is further restricted, and the second estimation pixel 312 having the minimum second predicted strength is taken as an initiation point. A plurality of third estimation blocks 32 is sequentially disposed in a counterclockwise direction. Each third estimation block 32 can be a quadrate block formed by third interval 321 in which the side length is two pixel lengths. Suppose a left upper corner of each third estimation block 32 is a third estimation pixel 322 to compare with and estimate the initial pixel. Since the second estimation pixel 312 of the position 1 has the greatest second predicted strength, each third estimation pixel 322 is sequentially disposed at positions of 17, 18, 19, 20, 21, 22, 23 and 24 so that each third estimation block 32 is sequentially and outwardly expanded to respectively obtain image data. According to image data in the first block 20, image data in the third estimation blocks 32 at positions of 17, 18, 19, 20, 21, 22, 23 and 24 is respectively compared to compute and obtain the sum of absolute difference between the third estimation blocks 32 and the first block 20 in order to find out the third predicted strength in each third estimation pixel 322. The third estimation pixel 322 having the greatest third predicted strength is a motion vector of the first pixel 200.

Since the third estimation pixel 322 at the position 21 has the greatest second predicted strength, the third estimation pixel 322 at the position 21 is taken as an initiation point to sequentially dispose a plurality of fourth estimation blocks 33. Each fourth estimation block 33 can be a quadrate block formed by four interval 331 in which a side length is a pixel length. Suppose a left upper corner of each fourth estimation block 33 is a fourth estimation pixel 332 that is used for comparing with and estimating the initial pixel. Each fourth estimation block 33 is disposed at positions of 25, 26, 27, 28, 29, 30, 31 and 32 to respectively obtain image data. Similarly, according to image data in the first block 20, image data in each fourth estimation block 33 is respectively compared to compute and obtain the sum of absolute difference between the fourth estimation blocks 33 and the first block 20 so as to find out a fourth predicted strength of each fourth estimation pixel 332.

In the embodiment, since the fourth estimation blocks 33 at the position 29 has the sum of the minimum absolute difference, the sum of the minimum absolute difference is a motion vector of the first pixel 200 in the X-shaped pattern 6. The fourth estimation pixel 332 at the position 29 is a moved position of the first pixel 200 in the X-shaped pattern 6.

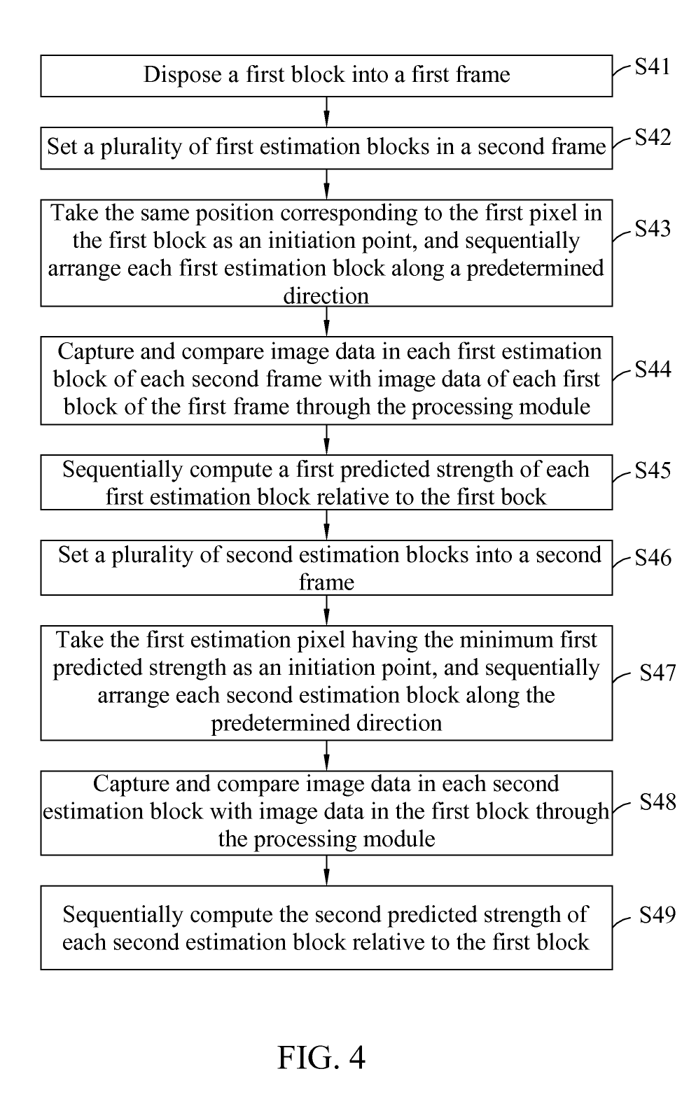

With reference to FIG. 4 for a flowchart of an image searching method according to a first embodiment of the invention is depicted. In the figure, the image searching method of the invention is applicable to a motion estimation of the dynamic image processing system. The image searching module is used for performing the search operation of motion vector, and the image searching module includes a storage module, a setting module and a processing module, wherein the storage module can store a first frame. The image searching method includes the following steps:

In step S41, dispose a first block in a first frame;

In step S42, set a plurality of first estimation blocks in which the side length is a first interval in a second frame through the setting module;

In step S43, in the second frame, take the same position of corresponding to the first pixel in the first block an initiation point, and sequentially arrange each first estimation block along a predetermined direction;

In step S44, capture and compare image data in each first estimation block of each second frame with image data of each first block of the first frame through the processing module;

In step S45, sequentially compute a first predicted strength of each first estimation block relative to the first bock;

In step S46, set a plurality of second estimation blocks, in which the side length is a second interval, into a second frame through the setting module;

In step S47, take the first estimation pixel having the minimum first predicted strength as an initiation point, and sequentially arrange each second estimation block along the predetermined direction;

In step S48, capture and compare image data in each second estimation block with image data in the first block through the processing module; and

In step S49, sequentially estimate the second predicted strength of each second estimation block relative to the first block.

The detail description and embodiments of the image searching method of the invention have been depicted in the image searching module of the invention and are not described herein anymore.

The image searching module and the searching method thereof of the invention can take a fundamental estimation range for searching by disposing the estimation blocks so as to expand the searching scope of each pixel, and the block taken as the estimation range can reduce searching times. In addition, since the size of side lengths of estimation blocks is different, the image searching scope can be gradually restricted to greatly decrease the computation and computation time of motion estimation.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An image searching module applicable to a motion estimation of a dynamic image processing system, comprising:
a storage module storing a first frame, the first frame comprising a first block, the first block comprising a first pixel;
a setting module for disposing a plurality of first estimation blocks in a second frame, each of the first estimation blocks comprising a first estimation pixel, and a first interval taken as a side length, the setting module taking a same position corresponding to the first pixel in the second frame as an initiation point, the plurality of first estimation blocks sequentially arranged along a predetermined direction; and
a processing module connected to the setting module, the processing module capturing and comparing image data in each of the first estimation blocks of the second frame with image data in each of the first blocks of the first frame to sequentially compute a first predicted strength of each of the first estimation blocks relative to the first block.

2. The image searching module as recited in claim 1, wherein the setting module further includes a plurality of second estimation blocks, each of the second estimation blocks has a second estimation pixel, a second interval is taken as the side length, and each of the second estimation blocks takes the first estimation pixel having a minimum first predicted strength as the initiation point and is sequentially arranged along the predetermined direction.

3. The image searching module as recited in claim 2, wherein the processing module captures and compares image data in each of the second estimation blocks with image data in the first block to sequentially compute a second predicted strength of each of the second estimation blocks relative to the first block.

4. The image searching module as recited in claim 3, wherein the setting module further comprises a plurality of third estimation blocks, and each of the third estimation blocks has a third estimation pixel, and a third interval is taken as the side length, and the third estimation blocks take the second estimation pixel having the minimum second predicted strength as the initiation point and are sequentially arranged along the predetermined direction.

5. The image searching module as recited in claim 4, wherein the processing module captures and compares image data in each of the third estimation blocks with image data in the first block to sequentially compute a third predicted strength of each of the third estimation blocks relative to the first block.

6. The image searching module as recited in claim 4, wherein the second interval is smaller than the first interval, and the third interval is smaller than the second interval.

7. The image searching module as recited in claim 5, wherein the processing module respectively captures and compares image data in the first block with image data in each of the first estimation blocks, image data in each of the second estimation blocks or image data in each of the third estimation blocks to sequentially compute and obtain a plurality of sums of absolute differences.

8. The image searching module as recited in claim 7, wherein the plurality of sums of absolute differences are respectively the first predicted strength, the second predicted strength or the third predicted strength.

9. An image searching method applicable to a motion estimation of a dynamic image processing system and using an image searching module to perform a search operation of motion vector, the image searching module comprising a storage module, a setting module and a processing module, the image searching method comprising the following steps:
storing a first frame through the storage module to dispose a first block in the first frame;
setting a plurality of first estimation blocks in a second frame through the setting module;
taking a first interval as a side length to respectively form each of the first estimation blocks;
taking a same position corresponding to a first pixel in the first block as an initiation point, and sequentially arranging each of the first estimation blocks along a predetermined direction;
capturing image data in each of the first estimation blocks and image data in the first block through the processing module;
comparing image data in each of the first estimation blocks of the second frame with image data in the first block of the first frame through the processing module; and
sequentially computing a first predicted strength of each of the first estimation blocks relative to the first block.

10. The image searching method as recited in claim 9, further comprising the following steps:
setting a plurality of second estimation blocks in the second frame through the setting module;
taking a second interval as the side length to respectively form each of the second estimation block; and
taking a first estimation pixel having a minimum first predicted strength as the initiation point, and sequentially arranging each of the second estimation block along the predetermined direction.

11. The image searching method as recited in claim 10, further comprising the following steps:
capturing and comparing image data in each of the second estimation blocks with image data in the first block through the processing module; and
sequentially computing a second predicted strength of each of the second estimation blocks relative to the first block.

12. The image searching method as recited in claim 11, further comprising the following steps:
disposing a plurality of third estimation blocks in the second frame through the setting module;
taking a third interval as the side length to respectively form each of the third estimation block; and
taking a second estimation pixel having a minimum second predicted strength as the initiation point, and sequentially arranging each of the third estimation blocks along the predetermined direction.

13. The image searching method as recited in claim 12, further comprising the following steps:
capturing and comparing image data in each of the third estimation blocks with image data in the first block through the processing module; and
sequentially computing a third predicted strength of each of the third estimation blocks relative to the first block.

14. The image searching method as recited in claim 12, wherein the second interval is smaller than the first interval, and the third interval is smaller than the second interval.

15. The image searching method as recited in claim 13, further comprising the following steps:
respectively capturing and comparing image data in the first block with image data in each of the first estimation blocks, image data in each of the second estimation blocks or image data in each of the third estimation blocks; and
computing and obtaining a plurality of sums of absolute differences of each of the first estimation blocks, each of the second estimation blocks or each of the third estimation blocks.

16. The image searching method as recited in claim 15, wherein the plurality of sums of absolute differences are respectively the first predicted strength, the second predicted strength or the third predicted strength.
